(19) United States
(12) Patent Application Publication
(10) Pub. No.: US 2024/0330396 A1
(43) Pub. Date: Oct. 3, 2024

(54) MICROGRID SPATIAL-TEMPORAL PERCEPTION ENERGY MANAGEMENT METHOD BASED ON SAFE DEEP REINFORCEMENT LEARNING

(71) Applicant: SOUTHEAST UNIVERSITY, Nanjing (CN)

(72) Inventors: Yujian YE, Nanjing (CN); Peiling CHEN, Nanjing (CN)

(73) Assignee: SOUTHEAST UNIVERSITY, Nanjing (CN)

(21) Appl. No.: 18/550,287

(22) PCT Filed: Mar. 14, 2023
(86) PCT No.: PCT/CN2023/081250

§ 371 Date: Sep. 12, 2023

(30) Foreign Application Priority Data
Nov. 22, 2022 (CN) 202211468976.2

(51) Int. Cl. G06F 17/11

(52) U.S. Cl. CPC G06F 17/11

(57) ABSTRACT

A microgrid spatial-temporal perception energy management method based on safe deep reinforcement learning includes: transforming an energy management problem of a microgrid (MG) into a constrained Markov decision process (CMDP), where an agent is an energy management agent of the MG; and solving the CMDP by using a safe deep reinforcement learning method, including: 1) building a feature extraction network combining an edge conditioned convolutional (ECC) network and a long short-term memory (LSTM) network to extract spatial and temporal features in a spatial-temporal operating status of the MG; and 2) endowing the agent with abilities to learn policy value and security simultaneously by using an interior-point policy optimization (IPO) algorithm. The microgrid spatial-temporal perception energy management method based on safe deep reinforcement learning enhances perception on the spatial-temporal operating status of the MG, safeguards the secure operation of the distribution network, and achieves superior energy management policy cost efficiency.

### CROSS REFERENCE TO THE RELATED APPLICATIONS

This application is the national phase entry of International Application No. PCT/CN2023/081250, filed on Mar. 14, 2023, which is based upon and claims priority to Chinese Patent Application No. 202211468976.2, filed on Nov. 22, 2022, the entire contents of which are incorporated herein by reference.

### TECHNICAL FIELD

The present disclosure belongs to the field of power system operation and control, and particularly relates to a microgrid spatial-temporal perception energy management method based on safe deep reinforcement learning.

### BACKGROUND

With the development of emerging power systems, a large number of small-scale distributed energy resources (DER), including various types of flexible loads, dispatchable generators (DG), and energy storage units, have been integrated into a distribution network. Therefore, it is necessary to design a microgrid (MG) energy management method that considers DER operation related complex characteristics and multi-source and spatial-temporal uncertainty, as well as their compliance with distribution network constraints.

The existing methods for MG energy management problem mainly include model-based and model-free optimization methods. However, for the former, explicit and accurate system modeling is often difficult in practice. In the latter, reinforcement learning (RL) constitutes a model-free control algorithm, by which an agent may gradually learn an optimal control policy based on experience obtained through repeated interaction with the environment without prior knowledge. However, the latter still has the following two unresolved problems: first, an effective energy management policy requires accurate perception on spatial-temporal operational characteristics of an MG; and second, in order to ensure normal operation of the distribution network, an energy management decision of the distribution network must comply with network constraints. However, considering complex distribution network constraints (such as node voltage constraints and thermal constraints of the distribution network) in the learning process of the agent is a huge challenge. The conventional trial and error type reinforcement learning/deep reinforcement learning method is based on a Markov decision process (MDP), which is usually formalized as an unconstrained optimization problem. In order to pursue constraint satisfaction, a naïve action rectification mechanism is integrated into an environment. This mechanism projects an unsafe behavior from a current policy to a nearest behavior that belongs to a feasible action space. However, the fundamental principle behind this correction process is hidden for the agent, so it is not embedded in the policy improvement process of the agent. Another commonly used method is to express constraint violation as a penalty term attached to a reward function. However, this method requires a tedious process to optimize related penalty factors. When a quantity of constraints is large, this process becomes more difficult. Therefore, an MG energy management policy optimization method based on safe deep reinforcement learning (SDRL) is provided.

### SUMMARY

In view of the shortcomings of existing technologies, the present disclosure is to provide a microgrid spatial-temporal perception energy management method based on safe deep reinforcement learning, which enhances perception on an MG spatial-temporal operating status, safeguards the secure operation of the distribution network, improves MG cost efficiency, and achieves superior energy management policy cost efficiency, and uncertainty adaptability.

The purpose of this disclosure can be achieved through the following technical solutions:

A microgrid spatial-temporal perception energy management method based on safe deep reinforcement learning, the method comprising the following steps:
transforming an energy management problem of a microgrid (MG) into a constrained Markov decision process (CMDP), wherein an agent is an energy management agent of the MG; and
solving the CMDP by using a safe deep reinforcement learning method, which comprises two parts: 1) building a feature extraction network combining an edge conditioned convolutional (ECC) network and a long short-term memory (LSTM) network to extract spatial and temporal features in a spatial-temporal operating status of the MG; and 2) endowing the agent with abilities to learn policy value and security simultaneously by using an interior-point policy optimization (IPO) algorithm;

Preferably, wherein the Markov decision process comprises: a state S, an action A, a reward r: S×A→ [symbol] , constraint violation c: S×A→ [symbol] ^{U} (cᵤ represents violation of constraint u, and U is a total number of constraints), a state transition function T(s, a, ω): S×A×W→S, and a conditional probability function P(s′|s, a, ω): S×A×W×S→S, wherein ω∈W represents stochasticity in the environment;
a stochastic policy π(aₜ|sₜ) determines to select an action in a state, and the agent interacts with the CMDP by using a policy π to form trajectories of state, action, reward, and cost: τ=(s₀, a₀, r₀, c₀, s₁, a₁, . . . ); and
the agent constructs a policy that maximizes cumulative discounted returns J(π)= [symbol] _{τ˜π}[Σₜ₌₀^{T}γ^{t}rₜ] and limits the policy π to a relevant feasible set Π_{c}={π: J_{Cu}(π)≤ξᵤ}, wherein T is a length of an energy management range, γ∈[0,1] is a discount factor, J_{Cu}(π) represents an expected discounted return of the policy π with respect to the auxiliary cost Cᵤ: J_{Cu}(π)= [symbol] _{τ˜π}[Σₜ₌₀^{T}γ^{t}_{Cu,t}]; and the CMDP can be formulated as the following constrained optimization:

$${max}_{π ∈ {Π}_{c}} J ( π ) = 𝔼 {}_{𝒯 ∼ π} [ {\sum }_{t = 0}^{T} {γ}^{t} {r}_{t} ]$$

$$s . t .$$

$${J}_{{C}_{u}} ( π ) \leq {ξ}_{u} ,$$

$$∀ u = 1 , … , U$$

$${J}_{{C}_{u}} ( π ) = 𝔼 {}_{𝒯 ∼ π} [ {\sum }_{t = 0}^{T} {γ}^{t} {c}_{u , t} ]$$

Preferably, the state S:

the state sₜ at step t reflects spatial-temporal perception on the operating status of the MG, and Zₜ represents information perceived in step t and is defined as follows:

Zₜ=(λₜ^{b,p},λₜ^{s,p},λₜ^{b,q},λₜ^{s,q},Hₜⁱⁿ,Hₜ^{out},P_{g,t}^{res},∀g∈N^{res},P_{d,t}^{dm},∀d∈N^{dm},E_{k,t}^{es},∀k∈N^{es},V_{n,t},∀n,S_{l,t},∀l)
in addition to price signal and temperature, node features P_{g}^{res}, P_{d}^{dm}, E_{k,t}^{es}, V_{n,t} and edge features S_{l,t} are also included in Zₜ;
the features of Zₜ are divided into endogenous features and exogenous features, wherein the endogenous features comprise RES generation P_{g}^{res} and non-flexible demand P_{d}^{dm}, which have inherent uncertainty and variability and are not dependent on an energy management behavior; the exogenous features comprise features E_{k,t}^{es}, Hₜⁱⁿ, and S_{l,t} as feedback signals for executed energy management actions; and
a Zₜ moving window composed of past W steps is used in a state vector sₜ to infer a future trend:

sₜ=(Zₜ,Zₜ₋₁, . . . ,Z_{t-W+1}).

Preferably, the action A:

the actions performed on the environment in step t comprise energy management actions for controllable devices such as dispatchable power generation equipment, a heating ventilation and air conditioning (HVAC) system, an energy storage system, and power exchange between the MG and a main network:

aₜ=(aₜ^{dg,p},aₜ^{dg,q},aₜ^{ac},aₜ^{es},aₜ^{gd,n},aₜ^{gd,n},aₜ^{res})
wherein the actions aₜ^{dg,p} and aₜ^{dg,q}∈[0,1] adjust magnitudes of active and reactive power output of the dispatchable power generation equipment, and the action aₜ^{ac}∈[0,1] adjusts a magnitude of the active power demand of the HVAC system; the action aₜ^{es} ∈[−1,1] adjusts a magnitude of charging (positive) or discharging (negative) power of the energy storage system; the action aₜ^{gd}∈[−1,1] determines a magnitude of active and reactive input (positive) or output (negative) between the MG and the main network; the actions aₜ^{pv} and aₜ^{wt}∈[0,1] provide reduction in photovoltaic and wind power; the policy πᵢ(aₜ|sₜ) may be approximated as a Gaussian distribution (citing a Gaussian policy) N(μ(sₜ),σ²), wherein μ(sₜ) and σ² are a mean value and standard deviation of the actions;
a state transition process from step t to step t+1 is determined by sₜ₊₁=T(sₜ, aₜ, wₜ), and its probability function is P(sₜ₊₁|sₜ, aₜ, wₜ) subject to comprehensive influence of current state sₜ, the agent's action aₜ, and environment stochasticity wₜ;
the HVAC power demand is managed by:

$${P}_{t}^{a c} = min ( max ( \frac{( {H}_{t}^{i n} - {\overline{H}}^{i n} ) {C}^{a c} {R}^{a c} - {H}_{t}^{i n} + {H}_{t}^{out}}{{η}^{a c} {R}^{a c}} , {a}_{t}^{a c} {\overline{P}}^{a c} ) , \frac{( {H}_{t}^{i n} - {\underline{H}}^{i n} ) {C}^{a c} {R}^{a c} - {H}_{t}^{i n} + {H}_{t}^{out}}{{η}^{a c} {R}^{a c}} )$$

when the charging or discharging power of the energy storage system is derived, maximum and minimum energy limits of the energy storage system are considered, and their management modes are as follows:

$${P}_{t}^{esc} = {[ min ( {a}_{t}^{es} {\overline{P}}_{t}^{es} , ( {\overline{E}}^{es} - {E}_{t}^{es} ) / ( {η}^{esc} Δ t ) ]}^{+}$$

$${P}_{t}^{esd} = {[ max ( {a}_{t}^{es} {\overline{P}}_{t}^{es} , ( {\underline{E}}^{es} - {E}_{t}^{es} ) / ( {η}^{esd} Δ t ) ]}^{-}$$

wherein [·]^{+/-}=max/min {.,0};
finally, active power Pₜ^{dg} and reactive power Qₜ^{dg} of a unit and active power exchange Pₜ^{gd} and reactive power exchange Qₜ^{gd} between the unit and the main network are computed according to the definitions.

Preferably, the constraints:

the optimization of specified energy management behaviors needs to comply with the following network constraints, denoted as B:

$${P}_{n , t}^{ex} = {\sum }_{m ∈ N} {V}_{n , t} {V}_{m , t} ( {G}_{n , m} cos {δ}_{n , m , t} + {B}_{n , m} sin {δ}_{n , m , t} ) ,$$

$$∀ n , ∀ t$$

$${Q}_{n , t}^{ex} = {\sum }_{m ∈ N} {V}_{n , t} {V}_{m , t} ( {G}_{n , m} sin {δ}_{n , m , t} + {B}_{n , m} cos {δ}_{n , m , t} ) ,$$

$$∀ n , ∀ t$$

$${\sum }_{n ∈ {N}^{gd}} {P}_{n , t}^{gd} + {\sum }_{g ∈ {N}^{d g}} {P}_{g , t}^{d g} + {\sum }_{g ∈ {N}^{res}} {P}_{g , t}^{res} = {\sum }_{d ∈ {N}^{d m}} {P}_{d , t}^{d m} + {\sum }_{j ∈ {N}^{a c}} {P}_{j , t}^{a c} + {\sum }_{k ∈ {N}^{es}} ( {P}_{k , t}^{esc} + {P}_{k , t}^{esd} ) + {P}_{n , t}^{ex} ,$$

$$∀ n , ∀ t$$

$${\sum }_{g ∈ {N}^{gd}} {Q}_{g , t}^{gd} + {\sum }_{Q ∈ {N}^{d g}} {P}_{g , t}^{d g} = {\sum }_{d ∈ {N}^{d m}} {Q}_{d , t}^{d m} + {Q}_{n , t}^{ex} ,$$

$$∀ n , ∀ t$$

$${P}_{l , t}^{2} + {Q}_{l , t}^{2} \leq {\overline{S}}_{l}^{2} ,$$

$$∀ l , ∀ t$$

$${\underline{V}}_{n , t} \leq {V}_{n , t} \leq {\overline{V}}_{n , t} ,$$

$$∀ n , ∀ t$$

a constraint is usually represented as a penalty item in a goal through a penalty factor κ: max J(π)+κf(Σᵤ^{U}J_{c}_{ᵤ}(π)−ξᵤ);
the goal is to minimize the penalty term f(Σᵤ^{U}Jcᵤ(π)−ξᵤ) and maximize the return J(π).

Preferably, the reward is defined as a negative total operating cost of the MG, comprising net procurement cost of the MG and the main network, total production cost of the dispatchable generator, and total cost of renewable energy reduction:

$${r}_{t} = - {{λ}_{t}^{b , p} [ {P}_{t}^{gd} ]}^{+} - {{λ}_{t}^{s , p} [ {P}_{t}^{gd} ]}^{-} - {{λ}_{t}^{b , q} [ {Q}_{t}^{gd} ]}^{+} - {{λ}_{t}^{s , q} [ {Q}_{t}^{gd} ]}^{-} - {c}^{d g , p} {P}_{t}^{d g} - {c}^{d g , q} {Q}_{t}^{d g} - {c}^{res , cu} {P}_{t}^{res , cu}$$

Preferably, steps of building a feature extraction network combining an ECC network and an LSTM network comprises: constituting input of an ECC layer based on spatial features Zₜ of the MG at a time step t, and extracting hidden spatial features as Xₜ at the same time step t; extracting, by LSTM neurons, a time dependency relationship between previous w steps X_{t-w-1:t} of the hidden spatial features as input to form accurate perception on their future (time) trends, denoted as Yₜ; and replacing an original state vector sₜ with the Yₜ as input of an agent policy network.

Preferably, the IPO algorithm controls satisfaction of security constraints by using a logarithmic barrier function; and an objective function of IPO consists of two parts: a chip agent objective of PPO L^{PPO}(·) and a logarithmic barrier function ϕ(·):

$${max}_{θ} {L}^{PPO} ( θ ) + {\sum }_{u} Φ ( ( {π}_{θ} ) )$$

$${L}^{PPO} ( θ ) = 𝔼 [ min ( {r}_{t} ( θ ) , clip ( {r}_{t} ( θ ) , 1 - ε , 1 + ε ) {A}_{t}^{r} ) ]$$

$${r}_{t} ( θ ) = {π}_{θ} ( {a}_{t} \vert {s}_{t} ) / {π}_{θ old} ( {a}_{t} \vert {s}_{t} )$$

$${A}_{t}^{r} = {δ}_{t}^{r} + γ {δ}_{t + 1}^{r} + … + {γ}^{T - t + 1} {δ}_{T - 1}^{r}$$

$${δ}_{t}^{r} = {r}_{t} + γ {V}_{ψ}^{r} ( {s}_{t + 1} ) - {V}_{ψ}^{r} ( {s}_{t} )$$

$${A}_{t}^{c} = {δ}_{t}^{c} + γ {δ}_{t + 1}^{c} + … + {γ}^{T - t + 1} {δ}_{T - 1}^{c}$$

$${δ}_{t}^{c} = {\sum }_{u} ( {c}_{u , t} - {ξ}_{u} ) + γ {V}_{ζ}^{c} ( {s}_{t + 1} ) - {V}_{ζ}^{c} ( {s}_{t} )$$

$$( {π}_{θ} ) = {A}_{t}^{c} {π}_{θ} ( {a}_{t} \vert {s}_{t} )$$

$$Φ ( ( {π}_{θ} ) ) = log ( - ( {π}_{θ} ) ) / q$$

wherein L^{PPO}(θ) represents the chip agent objective, ϕ( [symbol] (π_{θ})) represents the logarithmic barrier function, clip (·) is a clip function, and rₜ(θ) is within [1−ε,1+ε]; A^{r}, δ^{r}, and V_{ψ}^{r} represent an advantage function, a time difference error, and a state value function for evaluating the quality of an agent policy, respectively; A^{C}, δ^{C}, and V_{ψ}^{c} represent a same set of functions for evaluating the security of the agent policy, respectively; V_{ψ}^{r} and V_{ζ}^{c}(s) are separately evaluated by constructing two ψ and ζ parameterized critical networks.

According to another aspect of the present invention, a device is proposed, the device comprising one or more processors; and a memory, configured to store one or more programs, wherein when the one or more programs are executed by the one or more processors, the one or more processors are enabled to perform the microgrid spatial-temporal perception energy management method based on safe deep reinforcement learning according to any one of claims 1-8.

According to another aspect of the present invention, a computer-readable storage medium storing a computer program is proposed, when the program is executed by a processor, the microgrid spatio-temporal perception energy management method based on security deep reinforcement learning according to any one of claims 1-8 is implemented.

Beneficial effects of the present disclosure are as follows:

The microgrid spatial-temporal perception energy management method based on safe deep reinforcement learning transforms an energy management problem of a microgrid into a constrained Markov decision process, and considers stochasticity of exogenous factors, such as variability of renewable energy generation and demand. By using the advantages of ECC and LSTM networks, a feature extraction network is built to extract spatial-temporal related features of an operating status of the microgrid, which enhances the generalization capability of a control policy, solves the control policy by using a most advanced IPO method, enhances spatial-temporal perception on the operating status of the microgrid, and promotes learning in multi-dimensional and continuous states and action spaces. The quality of energy management policies is improved, and distribution network related constraints are satisfied.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, those of ordinary skill in the art may still derive other drawings from these drawings without any creative efforts.

FIG. 1 shows a structure of the proposed ECC-LSTM network;

FIG. 2 is an illustration of the modified IEEE 15-node test system;

FIG. 3 shows cumulative costs under different methods for 52 test days;

FIG. 4 shows MG energy management schedules in (1) unconstrained case and (2) constrained case, averaged over the 52 test days;

FIG. 5 shows indoor and outdoor temperatures averaged over the 52 test days;

FIG. 6 shows a comparison between the method of the present disclosure and existing technologies in terms of average thermal limit violation;

FIG. 7 shows a comparison between the method of the present disclosure and the existing technologies in terms of average voltage magnitude violation;

FIG. 8 shows a comparison between the method of the present disclosure and the existing technologies in terms of average microgrid cost; and

FIG. 9 shows a step relationship diagram of the method according to the present disclosure.

### DETAILED DESCRIPTION OF THE EMBODIMENTS

Technical solutions in the embodiments of the present disclosure will be clearly and completely described with reference to the accompanying drawings in the embodiments of the present disclosure. Apparently, the described embodiments are only some of the embodiments of the present disclosure, not all of them. All other embodiments obtained by those of ordinary skill in the art based on the embodiments of the present disclosure without creative efforts shall fall within the scope of protection of the present disclosure.

1. An energy management problem of a microgrid is transformed into a constrained Markov decision process (CMDP), which includes (1) state space S; (2) action space A; (3) reward r: S×A→ [symbol] ; (4) constraint violation c: S×A→ [symbol] ^{U} (cᵤ represents violation of constraint u, and U is the total number of constraints); (5) state transition function T(s, a, ω): S×A×W→S subject to a conditional probability function P(s′|s, a, ω): S×A×W×S→S where ω∈W represents stochasticity in the environment.

Which action is selected in a state is determined by a stochastic policy π(aₜ|sₜ). An agent interacts with the CMDP by using a policy π, and a trajectory of state, action, reward, and cost is formed: τ=(s₀, a₀, r₀, c₀, s₁, a₁ . . . ). The agent aims to construct a policy that maximizes cumulative discounted returns J(π)= [symbol] _{τ˜π}[Σₜ₌₀^{T}γ′rₜ] and limits the policy π to a relevant feasible set Π_{c}={π: J_{Cu}(π)≤ξᵤ}, where T is a length of an energy management range, γ∈[0,1] is a discount factor, J_{Cu}(π) represents an expected discounted return Cᵤ: J_{Cu}(π)= [symbol] _{τ˜π}[Σₜ₌₀^{T}γ′_{Cu,t}] of the policy π with respect to the auxiliary cost. The CMDP may be expressed as the following constrained optimization:

$${max}_{π ∈ {Π}_{c}} J ( π ) = 𝔼 {}_{𝒯 ∼ π} [ {\sum }_{t = 0}^{T} {γ}^{t} {r}_{t} ]$$

$$s . t .$$

$${J}_{{C}_{u}} ( π ) \leq {ξ}_{u} ,$$

$$∀ u = 1 , … , U$$

$${J}_{{C}_{u}} ( π ) = 𝔼 {}_{𝒯 ∼ π} [ {\sum }_{t = 0}^{T} {γ}^{t} {c}_{u , t} ]$$

### (1) State

In the tested problem, the state sₜ at step t reflects spatial-temporal perception on the operating status of the MG, which plays an important guiding role in a policy learning/optimization process. Zₜ represents information perceived in step t and is defined as follows:

Zₜ=(λₜ^{b,p},λₜ^{s,p},λₜ^{b,q},λₜ^{s,q},Hₜⁱⁿ,Hₜ^{out},P_{g,t}^{res},∀g∈N^{res},P_{d,t}^{dm},∀d∈N^{dm},E_{k,t}^{es},∀k∈N^{es},V_{n,t},∀n,S_{l,t},∀l)

In addition to a price signal and temperature, the information contained in Zₜ further includes node features P_{g}^{res}, P_{d}^{dm}, E_{k,t}^{es} and V_{n,t}, and an edge feature S_{l,t}. Moreover, the features of Zᵢ may be divided into endogenous features and exogenous features, where the endogenous features include RES generation P_{g}^{res}, non-flexible demand P_{d}^{dm}, and the like, which have inherent uncertainty and variability and are not dependent on an energy management behavior; and the latter includes features E_{k,t}^{es}, Hₜⁱⁿ, and S_{l,t} as feedback signals for executed energy management actions.

Zₜ includes spatial features observed at the current step t but cannot reflect their future dynamic trends. However, the latter is crucial for making effective energy management decisions. If the agent perceives a sharp increase in future loads, such as an increase in load flow of some distribution lines, the agent can correspondingly adjust management decisions of dispatchable power generation equipment and energy storage systems in advance. Therefore, a Zₜ moving window composed of past w steps is used in a state vector sₜ to infer a future trend:

sₜ=(Zₜ,Zₜ₋₁, . . . ,Z_{t-W+1})

### (2) Actions and State Transition

The actions performed on the environment in step t include energy management actions for controllable devices such as dispatchable power generation equipment, a heating ventilation and air conditioning system, an energy storage system, and power exchange between the MG and a main network:

aₜ=(aₜ^{dg,p},aₜ^{dg,q},aₜ^{ac},aₜ^{es},aₜ^{gd,n},aₜ^{gd,n},aₜ^{res})

The actions aₜ^{dg,p} and aₜ^{dg,q}∈[0,1] adjust magnitudes of active and reactive power output of the dispatchable power generation equipment, and the action aₜ^{ac}∈[0,1] adjusts a magnitude of the active power demand of the HVAC system; the action aₜ^{es} ∈[−1,1] adjusts a magnitude of charging (positive) or discharging (negative) power of the energy storage system; the action aₜ^{gd}∈[−1,1] determines a magnitude of active and reactive input (positive) or output (negative) between the MG and the main network; the actions aₜ^{pv} and aₜ^{wt}∈[0,1] provide reduction in photovoltaic and wind power. The design of the foregoing actions satisfies relevant power limitations. According to the definitions of the actions, the policy πᵢ(aₜ|sₜ) may be approximated as a Gaussian distribution (citing a Gaussian policy) N(μ(sₜ),σ²), wherein μ(sₜ) and σ² are a mean value and standard deviation of the foregoing actions.

The state transition process from step t to step t+1 is determined by sₜ₊₁=T(sₜ, aₜ, wₜ), and its probability function is P(sₜ₊₁|sₜ, aₜ, wₜ) subject to comprehensive influence of current state sₜ, the agent's action aₜ, and environment stochasticity wₜ;
the HVAC power demand is managed by:

$${P}_{t}^{a c} = min ( max ( \frac{( {H}_{t}^{i n} - {\overline{H}}^{i n} ) {C}^{a c} {R}^{a c} - {H}_{t}^{i n} + {H}_{t}^{out}}{{η}^{a c} {R}^{a c}} , {a}_{t}^{a c} {\overline{P}}^{a c} ) , \frac{( {H}_{t}^{i n} - {\underline{H}}^{i n} ) {C}^{a c} {R}^{a c} - {H}_{t}^{i n} + {H}_{t}^{out}}{{η}^{a c} {R}^{a c}} )$$

Similarly, when the charging or discharging power of the energy storage system is derived, maximum and minimum energy limits of the energy storage system should be considered, and their management modes are as follows:

$${P}_{t}^{esc} = {[ min ( {a}_{t}^{es} {\overline{P}}_{t}^{es} , ( {\overline{E}}^{es} - {E}_{t}^{es} ) / ( {η}^{esc} Δ t ) ]}^{+}$$

$${P}_{t}^{esc} = {[ max ( {a}_{t}^{es} {\overline{P}}_{t}^{es} , ( {\underline{E}}^{es} - {E}_{t}^{es} ) / ( {η}^{esc} Δ t ) ]}^{-}$$

where [·]^{+/-}=max/min {., 0}.

Finally, active power Pₜ^{dg} and reactive power Qₜ^{dg} of a unit and active power exchange Pₜ^{gd} and reactive power exchange Qₜ^{gd} between the unit and the main network may be automatically computed according to the definitions.

### (3) ACOPF Related Security Constraints

The optimization of specified energy management behaviors needs to comply with the following network constraints, denoted as B.

$${P}_{n , t}^{ex} = {\sum }_{m ∈ N} {V}_{n , t} {V}_{m , t} ( {G}_{n , m} cos {δ}_{n , m , t} + {B}_{n , m} sin {δ}_{n , m , t} ) ,$$

$$∀ n , ∀ t$$

$${Q}_{n , t}^{ex} = {\sum }_{m ∈ N} {V}_{n , t} {V}_{m , t} ( {G}_{n , m} sin {δ}_{n , m , t} + {B}_{n , m} cos {δ}_{n , m , t} ) ,$$

$$∀ n , ∀ t$$

$${\sum }_{n ∈ {N}^{gd}} {P}_{n , t}^{gd} + {\sum }_{g ∈ {N}^{d g}} {P}_{g , t}^{d g} + {\sum }_{g ∈ {N}^{res}} {P}_{g , t}^{res} = {\sum }_{d ∈ {N}^{d m}} {P}_{d , t}^{d m} + {\sum }_{j ∈ {N}^{a c}} {P}_{j , t}^{a c} + {\sum }_{k ∈ {N}^{es}} ( {P}_{k , t}^{esc} + {P}_{k , t}^{esd} ) + {P}_{n , t}^{ex} ,$$

$$∀ n , ∀ t$$

$${\sum }_{g ∈ {N}^{gd}} {Q}_{g , t}^{gd} + {\sum }_{Q ∈ {N}^{d g}} {P}_{g , t}^{d g} = {\sum }_{d ∈ {N}^{d m}} {Q}_{d , t}^{d m} + {Q}_{n , t}^{ex} ,$$

$$∀ n , ∀ t$$

$${P}_{l , t}^{2} + {Q}_{l , t}^{2} \leq {\overline{S}}_{l}^{2} ,$$

$$∀ l , ∀ t$$

$${\underline{V}}_{n , t} \leq {V}_{n , t} \leq {\overline{V}}_{n , t} ,$$

$$∀ n , ∀ t$$

The amplitude and phase angle of node voltage and the load flow direction of a distribution network are all influenced by energy management decisions of all controllable distributed resources.

Once a quantity of active and reactive power PQₜ(aₜ)={P_{g,t}^{dg}, Q_{g,t}^{dg}, P_{j,t}^{ac}, P_{k,t}^{es}, P_{n,t}^{gd}, Q_{n,t}^{gd}} is determined, a load flow may be simulated in the distribution network to evaluate states of all network constraints. In order to consider the security constraints in a conventional Markov decision process framework, a constraint is usually represented as a penalty item in a goal through a penalty factor κ:

$$max J ( π ) + kf ( {\sum }_{u}^{U} {J}_{{C}_{u}} ( π ) - {ξ}_{u} )$$

The goal is to minimize the penalty term f(Σᵤ^{U}Jcᵤ(π)−ξᵤ) and maximize the return J(π) To achieve this goal, the penalty factor κ is required to be appropriately selected to achieve an optimal balance between the two. If the value of ω is small, the behavior that violates the constraint cannot be fully punished. If the value of ω is large, the punishment for violating the constraint is excessive, leading to a decrease in the effectiveness of the energy management behavior.

### (4) Reward

The reward is defined as a negative total operating cost of the MG, including net procurement cost of the MG and the main network, total production cost of the dispatchable generator, and total cost of renewable energy reduction:

$${r}_{t} = - {{λ}_{t}^{b , p} [ {P}_{t}^{g d} ]}^{+} - {{λ}_{t}^{s , p} [ {P}_{t}^{g d} ]}^{-} - {{λ}_{t}^{b , q} [ {Q}_{t}^{g d} ]}^{+} - {{λ}_{t}^{s , q} [ {Q}_{t}^{g d} ]}^{-} - {c}^{d g , p} {P}_{t}^{d g} - {c}^{d g , q} {Q}_{t}^{d g} - {c}^{r e s , c u} {P}_{t}^{r e s , c u}$$

2. A feature extraction network combining an edge conditioned convolutional (ECC) network and a long short-term memory (LSTM) network is built, with a structure as shown in FIG. 1.

First, spatial features Zₜ of the MG at a time step t constitute input of an ECC layer, and hidden spatial features are extracted as Xₜ at the same time step t. Then, LSTM neurons extract a time dependency relationship between previous w steps X_{t-w-1:t} of the hidden spatial features as input to form accurate perception on their future (time) trends, denoted as Yₜ. The Yₜ replaces the original state vector sₜ as input of an agent policy network to enhance spatial-temporal perception capability. Working principles of the ECC network and the LSTM network are as follows:

### (1) Spatial Feature Extraction (ECC):

The power grid has a typical graph structured network, where buses are considered as nodes and edges, respectively. It is difficult to perceive and explain operational characteristics of an original transmission network based on spatial dependence of the real world. Although the convolutional neural network has advantages in extracting spatial relations in Euclidean space represented by two-dimensional images, it is essentially invalid when dealing with the topological structure and physical attributes of the power grid. To this end, a convolution operator is extended to non-Euclidean data by using a graph convolutional network (GCN). Further, the ECC network constitutes an improved version of the original GCN, and integrates three main attributes: an adjacency matrix, node features and edge features (edge features are ignored in the GCN structure).

A represents the adjacency matrix of nodes, where elements 1 and 0 represent connected and disconnected states of connecting lines separately. The adjacency matrix with self-joins is expressed as Ã, the degree matrix \tilde{D} is a diagonal matrix, and each element is \tilde{D}ᵢᵢ.

$$A ( i , j ) == \{ \begin{matrix}1 , if node i and j are connected \\ 0 , otherwise\end{matrix}$$

$$\tilde{A} = A + {I}_{N}$$

$${\tilde{D}}_{ii} = {Σ}_{j} {\tilde{A}}_{i , j}$$

F_{V} and F_{E} represent a node feature matrix and an edge feature matrix separately. At the input layer, F_{V}⁰ encapsulates node features; and F_{E}⁰ describes edge features.

Mathematically speaking, the ECC operation on node i essentially adds each edge label F_{E} to a dynamic filtering weight F:

$${X}_{t} ( i ) = \frac{1}{\overline{{D}_{ii}}} {\sum }_{j = 1}^{N} {\overline{A}}_{ij} F ( {F}_{E}^{0} ( j ) ; k ) {F}_{V}^{0} ( j ) + b = \frac{1}{\overline{{D}_{ii}}} {\sum }_{j = 1}^{N} {\overline{A}}_{ij} {Θ}_{ij} {F}_{V}^{0} ( j ) + b$$

where b is a trainable deviation and Θᵢⱼ is a dynamic edge parameter set.

### (2) Temporal Feature Extraction (LSTM):

The LSTM network is very effective in extracting time dependent features from time series data. Based on a standard RNN unit, a structure of an LSTM unit is improved by adding a forgetting gate, an update gate, and an output gate, so as to minimize a possibility of gradient vanishing/exploding. The principle formula is as follows:

$$[ \begin{matrix}{α}_{t} \\ {β}_{t} \\ {λ}_{t} \\ {μ}_{t}\end{matrix} ] = [ \begin{matrix}tanh \\ σ \\ σ \\ σ\end{matrix} ] ( W [ \begin{matrix}{X}_{t} \\ {h}_{t - 1}\end{matrix} ] ) + B$$

$${α}_{t} = {μ}_{t} ⊙ {α}_{t - 1} + {λ}_{t} ⊙ {α}_{t}$$

$${h}_{t} = {β}_{t} ⊙ tanh ( {α}_{t} )$$

$${Y}_{t} = {h}_{t}$$

W and B are a weight and deviation vector of each part of the LSTM unit. Xₜ, hₜ, and αₜ are input, output, and internal state of the time step t; λ, μ, and β are the input gate, the forgetting gate, and the output gate respectively; and σ and tanh are activation functions. The output of LSTM neurons is defined as spatial-temporal characteristics Yₜ of step t.

3. An interior-point policy optimization (IPO) algorithm for problem solving controls satisfaction of security constraints by using a logarithmic barrier function. According to settings of TO to alleviate problems, an ideal barrier should have two properties: 1) when security constraints are satisfied, the value of a barrier function should be zero; and 2) in the presence of any constraint violation, a large negative value (namely, penalty) should be introduced on an original objective function, but the value of the optimization penalty factor is not required to be exhausted. A policy update mechanism for IPO inherits proximal policy optimization (PPO), thereby reserving attributes of a trust region. Compared with a second-order algorithm TRPO, derivatives of PPO and IPO are computed by a first-order algorithm that is easy to implement.

An objective function of IPO consists of two parts: a chip agent objective of PPO L^{PPO}(·) and a logarithmic barrier function ϕ(·):

$${max}_{θ} {L}^{PPO} ( θ ) + {\sum }_{u} Φ ( ( {π}_{θ} ) )$$

$${L}^{PPO} ( θ ) = 𝔼 [ min ( {r}_{t} ( θ ) , clip ( {r}_{t} ( θ ) , 1 - ε , 1 + ε ) {A}_{t}^{r} ) ]$$

$${r}_{t} ( θ ) = {π}_{θ} ( {a}_{t} \vert {s}_{t} ) / {π}_{θ old} ( {a}_{t} \vert {s}_{t} )$$

$${A}_{t}^{r} = {δ}_{t}^{r} + γ {δ}_{t + 1}^{r} + … + {γ}^{T - t + 1} {δ}_{T - 1}^{r}$$

$${δ}_{t}^{r} = {r}_{t} + γ {V}_{ψ}^{r} ( {s}_{t + 1} ) - {V}_{ψ}^{r} ( {s}_{t} )$$

$${A}_{t}^{c} = {δ}_{t}^{c} + γ {δ}_{t + 1}^{c} + … + {γ}^{T - t + 1} {δ}_{T - 1}^{c}$$

$${δ}_{t}^{c} = {\sum }_{u} ( {c}_{u , t} - {ξ}_{u} ) + γ {V}_{ζ}^{c} ( {s}_{t + 1} ) - {V}_{ζ}^{c} ( {s}_{t} )$$

$$( {π}_{θ} ) = {A}_{t}^{c} {π}_{θ} ( {a}_{t} \vert {s}_{t} )$$

$$Φ ( ( {π}_{θ} ) ) = log ( - ( {π}_{θ} ) ) / q$$

Where clip (·) is a clip function, and rₜ(θ) is within [1−ε,1+ε]; A^{r}, δ^{r}, and V_{ψ}^{r} represent an advantage function, a time difference error, and a state value function for evaluating the quality of an agent policy, respectively; A^{C}, δ^{C}, and V_{ψ}^{c} represent a same set of functions for evaluating the security of the agent policy, respectively; V_{ψ}^{r} and V_{ζ}^{c}(s) are separately evaluated by constructing two ψ and ζ parameterized critical networks.

The barrier function ϕ(·) constitutes an approximate value of an ideal barrier function (or indicator function) I(·) defined in the following formula. As the q value increases, ϕ(·) is closer to I(·). In addition, the logarithmic barrier function has an advantage of first-order differentiability (but I(·) is not differentiable at the origin), which is completely consistent with a policy update mechanism for IPO.

$$I ( ( {π}_{θ} ) ) = \{ \begin{matrix}0 , ( {π}_{θ} ) \leq 0 \\ - ∞ , ( {π}_{θ} ) > 0\end{matrix}$$

In terms of policy improvement, IPO inherits a policy gradient method of PPO, and reserves the monotonicity of TRPO and the computational efficiency of PPO. The two properties are ideal for the MG energy management problem with high-dimensional complex states and action spaces. In addition, only the IPO method can improve policy quality and learn constraint satisfaction, which are basic requirements of the problem.

In a training process, the energy management agent of the MG uses the current policy to interact with the environment for a T time step size, and collects trajectories τ=(s₀, a₀, r₀, c₀, s₁, a₁, . . . , r_{T}, c_{T}) to represent the T time step size. For each complete trajectory τ, the agent evaluates advantage functions Aₜ^{r} and Aₜ^{c} based on output of critics V_{ϕ}^{r}(sₜ) and V_{ζ}^{c}(sₜ) separately. TD learning is trained by maximizing the objective function mentioned above and minimizing mean square TD errors δₜ^{r} and δₜ^{c} separately.

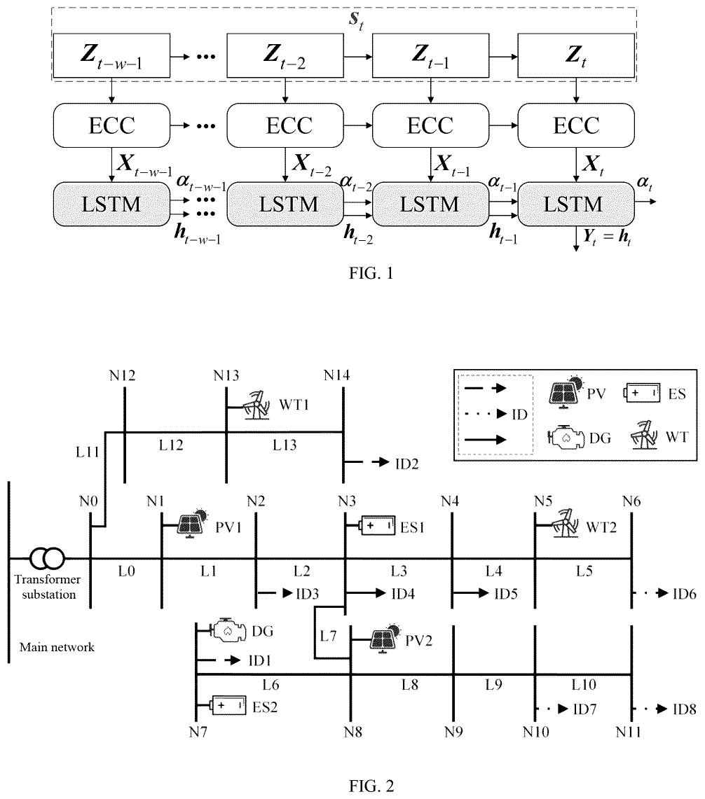

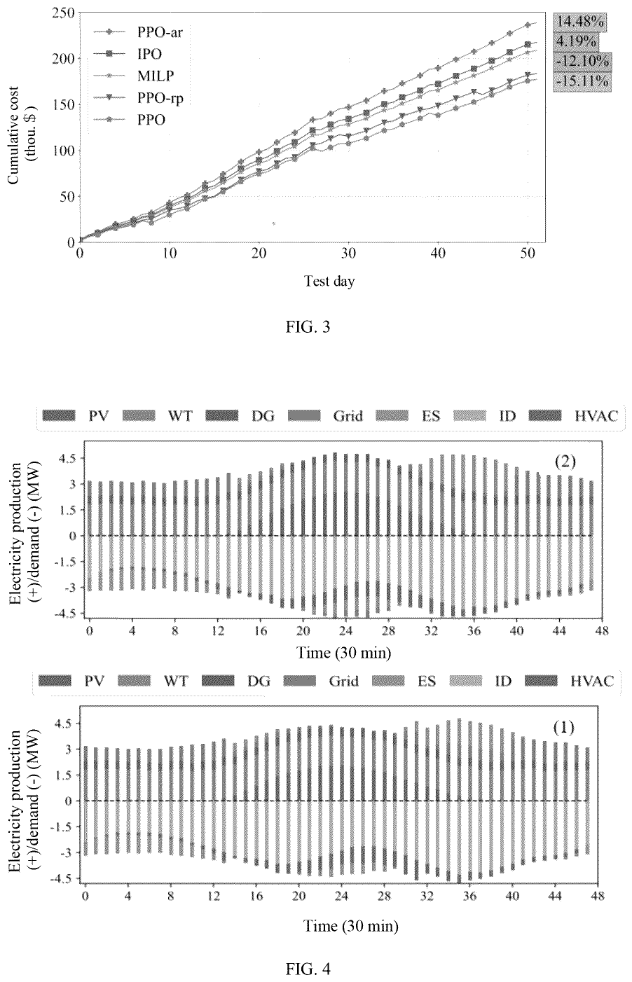

Cases were studied on a microgrid modified based on an IEEE 15 node test system. A structure of the microgrid is shown in FIG. 2. The microgrid includes 1 dispatchable generator (DG), 2 photovoltaics (PV), 2 wind turbines (WT), 2 energy storage systems (ES), and 8 inflexible demands (IDs) including industrial, residential, and commercial demands (illustrated from above). On this basis, a total of 60 heating ventilation and air conditioning (HVAC) systems are randomly distributed to these demand nodes. The MG may input/output power to the main network through node NO.

A thermal limit was set to 1.3 MVA, and amplitudes of voltage of all the nodes were between 0.9 p.u and 1.1 p.u. Time series data on residential demand, photovoltaic and wind power generation were collected from a real data set recorded by Australian distribution company Ausgrid. Relevant outdoor temperature data came from an open database of the Australian government. It was assumed that the cost and price related to reactive power are equal to 10% of the values related to active power.

To explore the generalization capability of the provided method, a one-year data set was divided into a training set and a test set. One day of 52 weeks was randomly selected to build the test set, and the remaining 313 days formed the training set.

In order to verify the cost efficiency and constraint satisfaction of the MG energy management policy of the provided method, the provided method was compared with three PPO-based methods:
(1) PPO: An original PPO method, in which the agent learned an energy management policy that ignored all security constraints;
(2) PPO-rp: The PPO can solve complex MDPs, but cannot be directly used to solve CMDPs. Behaviors that violated constraints were punished in a reward function rt, which was then redefined as rₜ^{MDP}=rₜ−kΣᵤc_{u,t};
(3) PPO-ar: The PPO employed a naïve behavior correction mechanism. If security constraints were violated, the environment will modify corresponding energy management behaviors by solving the following optimization problem:

$$arg {min}_{{a}^{s}} \frac{1}{2} {‖ {PQ}^{c} ( {a}^{c} ) - {PQ}^{s} ( {a}^{s} ) ‖}^{2}$$

$$s . t .$$

$${PQ}^{s} ( {a}^{s} ) ∈ B$$

In addition, the IPO was compared with a theoretical optimal controller (MILP), where the latter formalized the problem into a mixed integer linear programming, minimized daily MG cost as the goal, assumed full understanding of models and parameters of MG and DERs, and perfectly predicted uncertain parameters. In order to evaluate the average performance and related variability of the provided method and a baseline method, 10 different random seeds were generated, and each method trained 5000 sets for each seed, with each set representing a random day selected from the training set (namely, 313 days). During training, the performance of each method was regularly evaluated on the test set (every 100 sets).

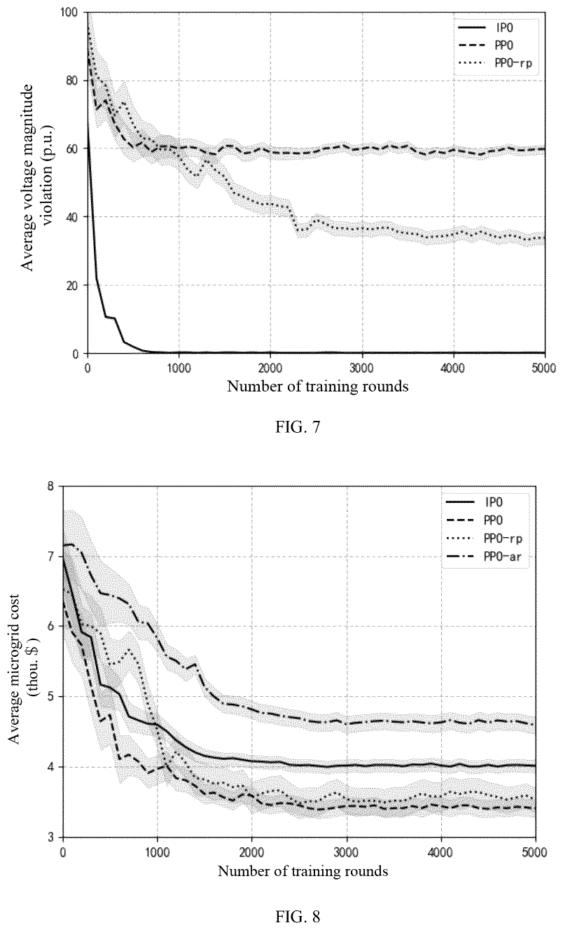

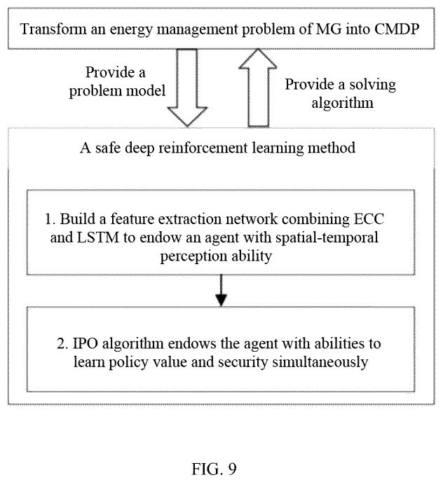

FIG. 6 and FIG. 7 illustrate average constraint violations of all inspected methods against a thermal limit and a node voltage amplitude in 52-day test, showing average constraint violations and standard deviations of 10 seeds through solid lines and shaded areas, respectively. Similarly, FIG. 8 shows average MG costs of all the methods in the 52-day test.

The following observations may be obtained from FIG. 6 and FIG. 7:
(1) Under the IPO conditions, two constraint violations were observed to rapidly decrease to zero within 1000 events, which demonstrated the effectiveness of the logarithmic barrier function in helping the agent to quickly learn constraint satisfaction;
(2) Under the PPO conditions, the two constraints were not considered in the training process, and both apparent load flow and node voltage at a convergence point were obviously violated;
(3) Under PPO-rp, the penalty method can only reduce constraint violations to a certain extent, but relatively large constraint violations were observed during convergence;
(4) PPO-ar corresponds to zero constraint violations (therefore not shown in the figures), because it satisfied network constraints in the training process.

As shown in FIG. 8, in a case that line flow and node voltage constraints were completely ignored, the PPO obtained the lowest average MG cost, the PPO-rp corresponded to the second lowest cost and the second highest large constraint violation behavior, indicating that the agent traded constraint violations for higher economic benefits. For IPO and PPAR, although the two methods ensured constraint satisfaction during convergence, the average MG cost under the IPO was significantly lower than that under the PPO-ar (14.48%). This proved that the provided IPO method systematically embedded a security learning mechanism into a policy improvement mechanism of the agent to promote synchronous improvement on security and quality.

52-day cumulative costs under the IPO and all the baseline methods were tested, as shown in FIG. 3. It may be observed that the IPO was close to the theoretical optimum (only 4.19% higher), indicating good generalization capability for invisible data sets. Under the PPO, the operating cost of the MG was significantly underestimated (15.11% lower than the MILP cost), which was a result of completely ignoring network constraints. Although the PPO-ar ensured the satisfaction of network constraints, the principle behind the behavior modification mechanism was not learned by the agent, so the PPO-ar was not considered in the policy update/improvement process of the agent, where the cumulative cost of the PPO-ar was 14.48% higher than the MILP cost. Under the PPO-rp, the constraint violation during convergence was still significant, so the cumulative cost was lower than the costs obtained under IPO and MILP (−12.10%), as the agent has learned to trade lower costs in some cases of violating network constraints.

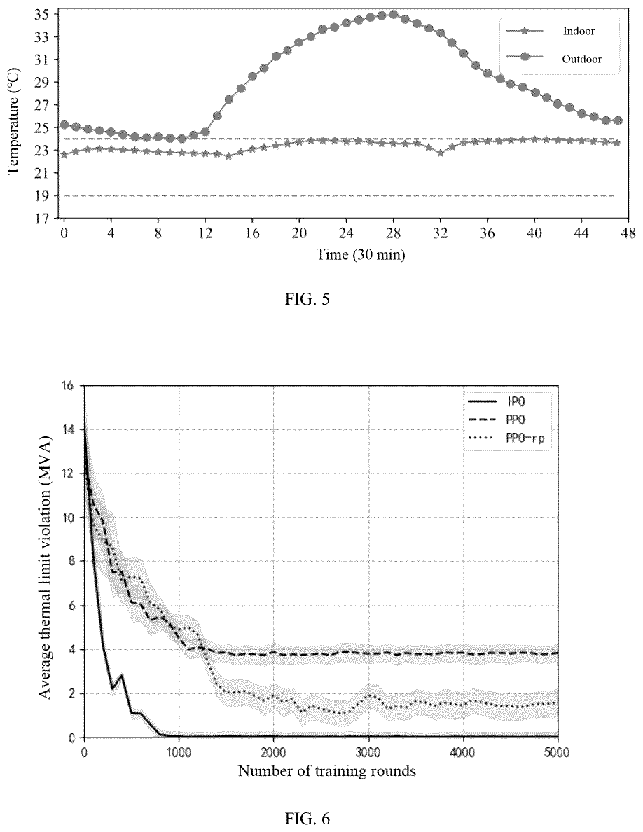

FIG. 4 shows charging (−) and discharging (+) power of ES, power output of DG, demand input of HVAC, and average power input (+) and output (−) between the MG and the main network in 52-day test in unconstrained (namely, ignoring network constraints) and constrained cases. Average indoor and outdoor temperatures are shown in FIG. 5. Common points can be observed:
(1) The ES system was scheduled during off-peak hours from 22:00 to 5:00 to utilize low and off-peak electricity prices;
(2) By charging the ES and providing ID and HVAC demands, photovoltaic and wind power generation were effectively utilized/absorbed, while the MG only imported from the grid during the lowest electricity price period;
(3) ES emissions were characterized by high ID and no/low PV production at 16:00-20:00;
(4) The HVAC system mainly operated at 7:00-16:00 to ensure that the indoor temperature was within a comfortable range when the outdoor temperature was high.

However, the two methods also exhibited significant differences: in the unconstrained cases, the MG may output remaining electricity to the main network (including rich RES and ES discharge) at 9:00-19:00 to earn additional income, which was achieved by ignoring all voltage and thermal limitations; and in the constrained cases, due to the consideration of voltage and heat flow limitations, the output performance was significantly reduced. Based on the same reasons, under limited circumstances, the discharge of ES was higher and the grid input was lower at 16:00-20:00, and the reduction of PV was lower at 8:00-16:00.

In the description of this specification, the reference term “one embodiment”, “example”, “specific example”, or the like indicates that the specific features, structures, materials, or characteristics described in conjunction with the embodiment or example are included in at least one embodiment or example of the present disclosure. In this specification, the schematic expressions of the above terms do not necessarily refer to the same embodiments or examples. Moreover, the described specific features, structures, materials, or characteristics may be combined in an appropriate manner in any one or more embodiments or examples.

The above shows and describes the basic principles, main features, and advantages of the present disclosure. Technicians in this industry should be aware that the present disclosure is not limited by the foregoing embodiments. The descriptions in the foregoing embodiments and specification only illustrate the principles of the present disclosure. The present disclosure may have various changes and improvements without departing from the spirit and scope of the present disclosure, and these changes and improvements fall within the scope of the present disclosure.

What is claimed is:

1. (canceled)

2. A microgrid spatial-temporal perception energy management method based on safe deep reinforcement learning, comprising the following steps:
transforming an energy management problem of a microgrid (MG) into a constrained Markov decision process (CMDP), wherein an agent is an energy management agent of the MG; and
solving the CMDP by using a safe deep reinforcement learning method, wherein the safe deep reinforcement learning method comprises two parts: 1) building a feature extraction network combining an edge conditioned convolutional (ECC) network and a long short-term memory (LSTM) network to extract spatial and temporal features in a spatial-temporal operating status of the MG; and 2) endowing the agent with abilities to learn policy value and security simultaneously by using an interior-point policy optimization (IPO) algorithm;
wherein the Markov decision process comprises: a state S, an action A, a reward r: S×A→ [symbol] , constraint violation c: S×A→ [symbol] ^{U} (cᵤ represents violation of constraint u, and U is a total number of constraints), a state transition function T(s, a, ω): S×A×W→S, and a conditional probability function P(s′|s, a, ω): S×A×W×S→S, wherein ω∈W represents stochasticity in an environment;
a stochastic policy π(aₜ|sₜ) determines to select an action in a state, and the agent interacts with the CMDP by using a policy π to form trajectories of state, action, reward, and cost: τ=(s₀, a₀, r₀, c₀, s₁, a₁, . . . ); and
the agent constructs a policy that maximizes cumulative discounted returns J(π)= [symbol] _{τ˜π}[Σₜ₌₀^{T}γ^{t}rₜ] and limits the policy π to a relevant feasible set Π_{c}={π: J_{Cu}(π)≤ξᵤ}, wherein T is a length of an energy management range, γ∈[0,1] is a discount factor, J_{Cu}(π) represents an expected discounted return of the policy π with respect to an auxiliary cost Cᵤ: J_{Cu}(π)= [symbol] _{τ˜π}[Σₜ₌₀^{T}γ^{t}_{Cu,t}]; and the CMDP is formulated as the following constrained optimization:
$${max}_{π ∈ {Π}_{c}} J ( π ) = 𝔼 {}_{𝒯 ∼ π} [ {\sum }_{t = 0}^{T} {γ}^{t} {r}_{t} ]$$
$$s . t .$$
$${J}_{{C}_{u}} ( π ) \leq {ξ}_{u} ,$$
$$∀ u = 1 , … , U$$
$${J}_{{C}_{u}} ( π ) = 𝔼 {}_{𝒯 ∼ π} [ {\sum }_{t = 0}^{T} {γ}^{t} {c}_{u , t} ] .$$

3. The microgrid spatial-temporal perception energy management method based on safe deep reinforcement learning according to claim 2, wherein the state S:
the state sₜ at step t reflects spatial-temporal perception on the operating status of the MG, and Zₜ represents information perceived in step t and is defined as follows:
Zₜ=(λₜ^{b,p},λₜ^{s,p},λₜ^{b,q},λₜ^{s,q},Hₜⁱⁿ,Hₜ^{out},P_{g,t}^{res},∀g∈N^{res},P_{d,t}^{dm},∀d∈N^{dm},E_{k,t}^{es},∀k∈N^{es},V_{n,t},∀n,S_{l,t},∀l)
wherein λₜ^{b,p}, λₜ^{s,p} represent buying and selling prices of active power of a power grid at step t, λₜ^{b,q}, λₜ^{s,q} represent buying and selling prices of reactive power of the power grid at step t, Hₜⁱⁿ, Hₜ^{out} represent indoor and outdoor temperatures at step t, P_{g}^{res}, P_{d}^{dm}, E_{k,t}^{es}, and d V_{n,t} represent node features such as active output of a renewable energy generator, active and reactive power demands, battery energy, and node voltage amplitude at step t, and S_{l,t} represents apparent power of a line;
the features of Zₜ are divided into endogenous features and exogenous features, wherein the endogenous features comprise RES generation P_{g}^{res} and non-flexible demand P_{d}^{dm}, which have inherent uncertainty and variability and are not dependent on an energy management behavior; the exogenous features comprise features E_{k,t}^{es}, Hₜⁱⁿ, and S_{l,t} as feedback signals for executed energy management actions; and
a Zₜ moving window composed of past W steps is used in a state vector sₜ to infer a future trend:
sₜ=(Zₜ,Zₜ₋₁, . . . ,Z_{t-W+1}).

4. The microgrid spatial-temporal perception energy management method based on safe deep reinforcement learning according to claim 2, wherein the action A:
the actions performed on the environment in step t comprise energy management actions for controllable devices such as dispatchable power generation equipment, a heating ventilation and air conditioning (HVAC) system, an energy storage system, and power exchange between the MG and a main network:
aₜ=(aₜ^{dg,p},aₜ^{dg,q},aₜ^{ac},aₜ^{es},aₜ^{gd,n},aₜ^{gd,n},aₜ^{res})
wherein the actions aₜ^{dg,p} and aₜ^{dg,q}∈[0,1] adjust magnitudes of active and reactive power output of the dispatchable power generation equipment, and the action aₜ^{ac}∈[0,1] adjusts a magnitude of the active power demand of the HVAC system; the action aₜ^{es} ∈[−1,1] adjusts a magnitude of charging (positive) or discharging (negative) power of the energy storage system; the action aₜ^{gd}∈[−1,1] determines a magnitude of active and reactive input (positive) or output (negative) between the MG and the main network; the actions aₜ^{pv} and aₜ^{wt}∈[0,1] provide reduction in photovoltaic and wind power; the policy πᵢ(aₜ|sₜ) may be approximated as a Gaussian distribution (citing a Gaussian policy) N(μ(sₜ),σ²), wherein μ(sₜ) and σ² are a mean value and standard deviation of the actions;
a state transition process from step t to step t+1 is determined by sₜ₊₁=T (sₜ,aₜ,wₜ), and its probability function is P(sₜ₊₁|sₜ,aₜ,wₜ) subject to comprehensive influence of environment current state sₜ, the agent's action aₜ, and environment stochasticity wₜ;
the HVAC power demand is managed by:
$${P}_{t}^{a c} = m i n ( m a x ( \frac{( {H}_{t}^{i n} - {\overline{H}}^{i n} ) {C}^{a c} {R}^{a c} - {H}_{t}^{i n} + {H}_{t}^{o u t}}{{η}^{a c} {R}^{a c}} , {a}_{t}^{a c} {\overline{P}}^{a c} ) , \frac{( {H}_{t}^{i n} - {\underline{H}}^{i n} ) {C}^{a c} {R}^{a c} - {H}_{t}^{i n} + {H}_{t}^{o u t}}{{η}^{a c} {R}^{a c}} )$$
wherein Pₜ^{ac} represents a power demand of the HVAC system at step t, C^{ac} represents a heat capacity of the HVAC system, η^{ac} represents efficiency of the HVAC system, and R^{ac} represents thermal resistance of the HVAC system;
when the charging or discharging power of the energy storage system is derived, maximum and minimum energy limits of the energy storage system are considered, and their management modes are as follows:
$${P}_{t}^{esc} = {[ min ( {a}_{t}^{es} {\overline{P}}_{t}^{es} , ( {\overline{E}}^{es} - {E}_{t}^{es} ) / ( {η}^{esc} Δ t ) ]}^{+}$$
$${P}_{t}^{esd} = {[ max ( {a}_{t}^{es} {\overline{P}}_{t}^{es} , ( {\underline{E}}^{es} - {E}_{t}^{es} ) / ( {η}^{esd} Δ t ) ]}^{-}$$
wherein [·]^{+/-}=max/min {.,0}, Pₜ^{esc}, Pₜ^{esd} represent charging and discharging power of a battery at step t, aₜ^{es} represents an action of the battery at step t, Eₜ^{es} represents charging or discharging power of the battery at step t, Ē^{es}, E^{es} represent maximum and minimum energy limits of the battery, and η^{esc}, n^{esd} represent charging and discharging efficiency of the battery; and
finally, active power Pₜ^{dg} and reactive power Qₜ^{dg} of a unit and active power exchange Pₜ^{gd} and reactive power exchange Qₜ^{gd} between the unit and the main network are computed according to the definitions.

5. The microgrid spatial-temporal perception energy management method based on safe deep reinforcement learning according to claim 2, wherein the constraints:
the optimization of specified energy management behaviors needs to comply with the following network constraints, denoted as B:
$${P}_{n , t}^{e x} = {\sum }_{m ∈ N} {V}_{n , t} {V}_{m , t} ( {G}_{n , m} cos {δ}_{n , m , t} + {B}_{n , m} sin {δ}_{n , m , t} ) ,$$
$$∀ n , ∀ t$$
$${Q}_{n , t}^{e x} = {\sum }_{m ∈ N} {V}_{n , t} {V}_{m , t} ( {G}_{n , m} sin {δ}_{n , m , t} + {B}_{n , m} cos {δ}_{n , m , t} ) ,$$
$$∀ n , ∀ t$$
$${\sum }_{n ∈ {N}^{g d}} {P}_{n , t}^{g d} + {\sum }_{g ∈ {N}^{d g}} {P}_{g , t}^{d g} + {\sum }_{g ∈ {N}^{r e s}} {P}_{g , t}^{r e s} = {\sum }_{d ∈ {N}^{d m}} {P}_{d , t}^{d m} + {\sum }_{j ∈ {N}^{a c}} {P}_{j , t}^{a c} + {\sum }_{k ∈ {N}^{e s}} ( {P}_{k , t}^{e s c} + {P}_{k , t}^{e s d} ) + {P}_{n , t}^{e x} ,$$
$$∀ n , ∀ t$$
$${\sum }_{g ∈ {N}^{g d}} {Q}_{g , t}^{g d} + {\sum }_{Q ∈ {N}^{d g}} {P}_{g , t}^{d g} = {\sum }_{d ∈ {N}^{d m}} {Q}_{d , t}^{d m} + {Q}_{n , t}^{e x} ,$$
$$∀ n , ∀ t$$
$${P}_{l , t}^{2} + {Q}_{l , t}^{2} \leq {\overline{S}}_{l}^{2} ,$$
$$∀ l , ∀ t$$
$${\underline{V}}_{n , t} \leq {V}_{n , t} \leq {\overline{V}}_{n , t} ,$$
$$∀ n , ∀ t$$
the above formulas represent active/reactive power exchange between node n and other nodes, active/reactive power balance between nodes, and operational constraints on line capacity and node voltage amplitude, wherein P_{n,t}^{ex},Q_{n,t}^{ex} represents all active and reactive power output by node n, V_{n,t} represents a voltage amplitude of node n at step t, B_{n,m}, G_{n,m} represent admittance and conductance of a line between node n and m, δ_{n,m,t} represents a phase angle of node n and m at step t, P_{g,t}^{dg}, Q_{g,t}^{dg} represent active and reactive power generation of a dispatchable generator at step t, and P_{l,t},Q_{l,t} represents active, reactive, and apparent power on line 1 at step t;
a constraint is usually represented as a penalty item in a goal through a penalty factor κ: max J(π)+κf(Σᵤ^{U} J_{c}_{ᵤ} (π)−ξᵤ);
the goal is to minimize the penalty term f(Σᵤ^{U}Jcᵤ(π)−ξᵤ) and maximize the return J(π); to achieve this goal, the penalty factor κ is required to be appropriately selected to achieve an optimal balance between the two, wherein J_{C}_{ᵤ}(π) represents an expected discounted return with respect to the auxiliary cost cᵤ when the policy π is implemented.

6. The microgrid spatial-temporal perception energy management method based on safe deep reinforcement learning according to claim 2, wherein the reward is defined as a negative total operating cost of the MG, comprising net procurement cost of the MG and the main network, total production cost of the dispatchable generator, and total cost of renewable energy reduction:
$${r}_{t} = - {{λ}_{t}^{b , p} [ {P}_{t}^{g d} ]}^{+} - {{λ}_{t}^{s , p} [ {P}_{t}^{g d} ]}^{-} - {{λ}_{t}^{b , q} [ {Q}_{t}^{g d} ]}^{+} - {{λ}_{t}^{s , q} [ {Q}_{t}^{g d} ]}^{-} - {c}^{d g , p} {P}_{t}^{d g} - {c}^{d g , q} {Q}_{t}^{d g} - {c}^{r e s , c u} {P}_{t}^{r e s , c u}$$
wherein rₜ represents a reward function, pₜ^{dg}/Qₜ^{dg} represents active/reactive generation power of the dispatchable generator at step t, c^{dg,p}/c^{dg,q} represents active/reactive generation cost of the dispatchable generator, c^{res,cu} represents cost of renewable energy reduction, and Pₜ^{res,cu} represents power of renewable energy reduction at step t.

7. The microgrid spatial-temporal perception energy management method based on safe deep reinforcement learning according to claim 2, wherein steps of building the feature extraction network combining the ECC network and the LSTM network comprises: constituting input of an ECC layer based on spatial features Zₜ of the MG at a time step t, and extracting hidden spatial features as Xₜ at the same time step t; extracting, by LSTM neurons, a time dependency relationship between previous w steps X_{t-w-1:t} of the hidden spatial features as input to form accurate perception on their future (time) trends, denoted as Yₜ; and replacing an original state vector sₜ with the Yₜ as input of an agent policy network.

8. A microgrid spatial-temporal perception energy management method based on safe deep reinforcement learning, comprising the following steps:
transforming an energy management problem of a microgrid (MG) into a constrained Markov decision process (CMDP), wherein an agent is an energy management agent of the MG; and
solving the CMDP by using a safe deep reinforcement learning method, wherein the safe deep reinforcement learning method comprises two parts: 1) building a feature extraction network combining an edge conditioned convolutional (ECC) network and a long short-term memory (LSTM) network to extract spatial and temporal features in a spatial-temporal operating status of the MG; and 2) endowing the agent with abilities to learn policy value and security simultaneously by using an interior-point policy optimization (IPO) algorithm;
wherein the IPO algorithm controls satisfaction of security constraints by using a logarithmic barrier function; and an objective function of IPO consists of two parts: a chip agent objective of PPO L^{PPO}(·) and a logarithmic barrier function ϕ(·):
$${max}_{θ} {L}^{PPO} ( θ ) + {\sum }_{u} Φ ( ( {π}_{θ} ) )$$
$${L}^{PPO} ( θ ) = 𝔼 [ min ( {r}_{t} ( θ ) , clip ( {r}_{t} ( θ ) , 1 - ε , 1 + ε ) {A}_{t}^{r} ) ]$$
$${r}_{t} ( θ ) = {π}_{θ} ( {a}_{t} \vert {s}_{t} ) / {π}_{θ old} ( {a}_{t} \vert {s}_{t} )$$
$${A}_{t}^{r} = {δ}_{t}^{r} + γ {δ}_{t + 1}^{r} + … + {γ}^{T - t + 1} {δ}_{T - 1}^{r}$$
$${δ}_{t}^{r} = {r}_{t} + γ {V}_{ψ}^{r} ( {s}_{t + 1} ) - {V}_{ψ}^{r} ( {s}_{t} )$$
$${A}_{t}^{c} = {δ}_{t}^{c} + γ {δ}_{t + 1}^{c} + … + {γ}^{T - t + 1} {δ}_{T - 1}^{c}$$
$${δ}_{t}^{c} = {\sum }_{u} ( {c}_{u , t} - {ξ}_{u} ) + γ {V}_{ζ}^{c} ( {s}_{t + 1} ) - {V}_{ζ}^{c} ( {s}_{t} )$$
$$( {π}_{θ} ) = {A}_{t}^{c} {π}_{θ} ( {a}_{t} \vert {s}_{t} )$$
$$Φ ( ( {π}_{θ} ) ) = log ( - ( {π}_{θ} ) ) / q$$
wherein L^{PPO}(θ) represents a chip agent objective, ϕ( [symbol] (π_{θ})) represents a logarithmic barrier function, clip (·) is a clip function, and rₜ(θ) is within [1−ε,1+ε]; A^{r}, δ^{r}, and V_{ψ}^{r} represent an advantage function, a time difference error, and a state value function for evaluating the quality of an agent policy, respectively; A^{C}, δ^{C}, and V_{ψ}^{C} represent a same set of functions for evaluating the security of the agent policy, respectively; V_{ψ}^{r} and V_{ζ}^{C}(s) are separately evaluated by constructing two ψ and ζ parameterized critical networks.

9-10. (canceled)
